(19) United States
(12) Patent Application Publication
(10) Pub. No.: US 2002/0148062 A1
(43) Pub. Date: Oct. 17, 2002

(54) Paint roller frame

(76) Inventor: Leonard Lee Charbeneau, Temple, TX (US)

Correspondence Address: Leonard L. Charbeneau, P.O. Box 877, Belton, TX, 76513, US

(21) Appl. No.: 10/116,153

(22) Filed: Apr. 4, 2002

Related U.S. Application Data
(60) Provisional application No. 60/283,427, filed on Apr. 11, 2001.

(51) Int. Cl. B05C 17/02

(52) U.S. Cl. 15/230.11; 492/13; 492/19

(57) ABSTRACT

A paint roller frame with a 31 degree fixed forward angle with a 360 degree loop in the center of the angle that allow the user to directly apply paint materials to any surface with less effort and more control.

### CROSS-REFERENCE TO RELATED APPLICATIONS

U.S. Pat. No. 4,089,082 May 1978 McGrew 15/230

U.S. Pat. No. 5,261,142 November 1993 Linn et. al 15/145

U.S. Pat. No. 5,860,902 January 1999 Jang et. al. 492/13

U.S. Pat. No. 4,528,714 July 1985 Beck 15/230.11

### BACKGROUND OF INVENTION

A provisional patent application No. 60/283,427 filing date Apr. 11, 2001 has been applied for. This invention relates generally to paint roller frames and more specifically to improvements to the paint roller applicator frames that allow the user to directly apply paint materials to any surface with less effort and more control.

### PRIOR ART

U.S. Pat. No. 4,089,082 discloses a paint roller frame with a standard straight frame with an adjustable brace to allow changing rolling direction

U.S. Pat. No. 5,261,142 discloses a paint roller frame having a wire coil female thread for attaching a handle or an extension pole to.

U.S. Pat. No. 5,860,902 discloses a paint roller frame having an adjustable handle.

U.S. Pat. No. 4,528,714 discloses a paint roller frame with an adjustable handle.

### DETAILED DESCRIPTION OF THE INVENTION

The Concept of paint roller applicators is well known in the art. In general, a paint roller applicator included a frame made up of a roller cage assembly, a shaft and a handle. The shaft is usually a properly bent metallic rod with one end connected to or integral with the roller cage, while the other end connected to or partially embedded in a plastic or wood based handle.

The metallic rod is typically bent at two or three locations so that the rod can be considered to consist of three or four segments each being a substantially straight member. The last shaft member is normally connected to a handle in such a fashion that the axis is substantially perpendicular to the roller cage axis.

Some paint roller frames are made from plastic and can break when force or pressure is applied to them when applying paint materials.

The present invention provides an improved paint roller frame made from one solid piece of metallic rod with a 31 degree forward angle formed in the shaft with a single 360 degree loop in the center of the 31 degree forward angle.

No adjustments are required to use this paint roller frame, there fore there are no parts to break, misplace or get paint materials embedded in.

When applying paint materials to horizontal vertical surfaces with a standard straight shaft roller frame, much force is required to push the roller applicator to the surface to spread the coating. With this improved design roller frame, the fixed 31 degree forward angle helps apply paint materials to any surface, horizontal or vertical with less effort or force. When you push this paint roller frame up a vertical surface to apply paint materials, the upward movement forces the paint roller frame to push forward into the surface to be painted. The single 360-degree loop in the center of the 31-degree forward angle flexes to help the roller applicator keep in contact with the surface to be coated.

When applying paint materials on horizontal surfaces this improved design roller frame can be turned over with the 31 degree angle down towards the surface being rolled it can be pushed under objects and obstructions with ease from an upright position when used with a pole extension attached to the handle.

This improved roller frame is also designed to be used to paint downward from over head positions to apply coatings from structures such as bridge walkways or roadways over the wall or rails with a extension pole attached to the handle to apply a coating with less effort, more control and safer due to the forward 31 degree angle.

### BRIEF SUMMARY OF THE INVENTION

The present invention provides an improved paint roller frame made from one solid piece of metallic rod with a 31 degree forward angle formed in the shaft with a single 360 degree loop in the center of the 31 degree forward angle.

When applying paint materials to horizontal vertical surfaces with a standard straight shaft roller frame, much force is required to push the roller applicator to the surface to spread the coating. With this improved design roller frame, the fixed 31 degree forward angle helps apply paint materials to any surface, horizontal or vertical with less effort or force. The single 360-degree loop in the center of the 31-degree forward angle flexes to help the roller applicator keep in contact with the surface to be coated.

When applying paint materials on horizontal surfaces this improved design roller frame can be turned over with the 31 degree angle down towards the surface being rolled it can be pushed under objects and obstructions with ease from an upright position when used with a pole extension attached to the handle.

This improved roller frame is also designed to be used to paint downward from over head positions to apply coatings from structures such as bridge walkways or roadways over the wall or rails with a extension pole attached to the handle to apply a coating with less effort, more control and safer due to the forward 31 degree angle.

### DESCRIPTION OF ART

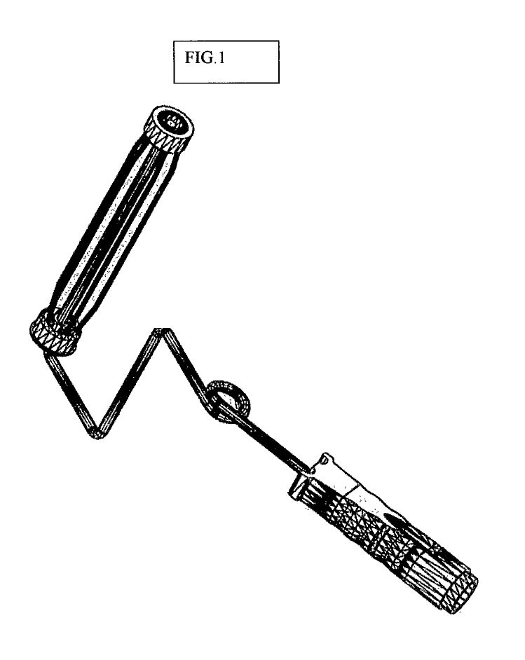

FIG. 1 shows a left side elevation view of a paint roller frame showing my new design;

FIG. 2 is a right side elevation view of a paint roller frame showing my new design;

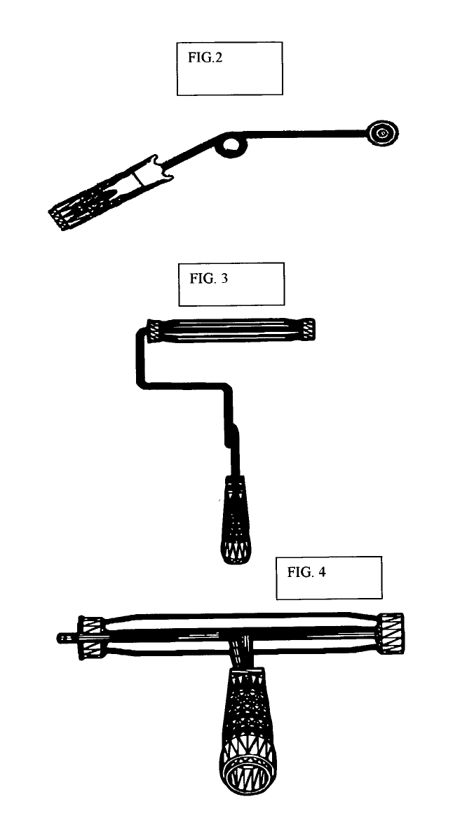

FIG. 3 is a top view elevation of a paint roller showing my new design;

FIG. 4 is a rear view elevation of a paint roller showing my new design.

### DETAILED DESCRIPTION OF THE INVENTION

The present invention provides an improved paint roller frame made from one solid piece of steel rod with a 31 degree forward angle formed in the shaft with a single 360 degree loop in the center of the 31 degree forward angle.

When applying paint materials to horizontal vertical surfaces with a standard straight shaft roller frame, much force is required to push the roller applicator to the surface to spread the coating. With this improved design roller frame, the fixed 31 degree forward angle helps apply paint materials to any surface, horizontal or vertical with less effort or force. The single 360-degree loop in the center of the 31-degree forward angle flexes to help the roller applicator keep in contact with the surface to be coated.

When applying paint materials on horizontal surfaces this improved design roller frame can be turned over with the 31 degree angle down towards the surface being rolled it can be pushed under objects and obstructions with ease from an upright position when used with a pole extension attached to the handle.

This improved roller frame is also designed to be used to paint downward from over head positions to apply coatings from structures such as bridge walkways or roadways over the wall or rails with a extension pole attached to the handle to apply a coating with less effort, more control and safer due to the forward 31 degree angle.

I claim:

1. A paint roller frame with a forward 31 degree angle in the shaft

2. A paint roller frame with a 360 degree loop in the center of the 31 degree forward angle
